(19) United States
(12) Patent Application Publication
(10) Pub. No.: US 2019/0080211 A1
(43) Pub. Date: Mar. 14, 2019

(54) Magnetic Card Reader

(71) Applicant: NIDEC SANKYO CORPORATION, NAGANO (JP)

(72) Inventor: Mamoru MIZAWA, NAGANO (JP)

(73) Assignee: NIDEC SANKYO CORPORATION, NAGANO (JP)

(21) Appl. No.: 16/127,258

(22) Filed: Sep. 11, 2018

(30) Foreign Application Priority Data
Sep. 12, 2017 (JP) 2017-174782

(51) Int. Cl. G06K 13/08; G06K 7/08

(52) U.S. Cl. CPC G06K 13/0856; G06K 13/0806; G06K 13/0862; G06K 7/087

(57) ABSTRACT

A magnetic card reader is provided and includes the holder which is movable both in the card-inserting direction and the card-ejecting direction in the card pathway. The magnetic card is held in the holder which is energized in the card-ejecting direction. Therefore, when the card latch lever is retracted, the auto eject operation of the magnetic card is implemented. The distance between the card-receiving surface on the holder positioned in the insertion-waiting position and the reading-writing position in the X direction is longer than the length from the edge of the magnetic card on the back side X2 to the edge of the magnetic data recording range on the front side X1. Therefore, the magnetic card is prevented from hitting the card-receiving surface and therefore from receiving impact while the magnetic data recording range on the magnetic card is passing the reading-writing position.

### CROSS REFERENCE TO RELATED APPLICATION

The present application claims priority under 35 U.S.C. § 119 to Japanese Application No. 2017-174782 filed Sep. 12, 2017, the entire content of which is incorporated herein by reference.

### TECHNICAL FIELD

The present disclosure relates to a magnetic card reader equipped with a magnetic head.

### DESCRIPTION OF THE RELATED DOCUMENTS

Patent Reference 1 discloses a card reader (an IC card reader) for reading data recorded in an IC chip on an IC card or for writing data in an IC chip on an IC card. To use the card reader of Patent Reference 1, a user inserts an IC card at a card insertion slot and pushes the card by hand into the position at which an IC contact block inside the card reader contacts a contact terminal on the card surface. The IC card is inserted into a holding body (a contact head holding body), which is provided to be slidable inside the card reader, and then pushed to the inside of the card reader while being held in the holding body.

The card reader of Patent Reference 1 is equipped with a latch mechanism to prevent cards from being pulled out. The latch mechanism locks a card with a lock craw, which protrudes to the card insertion slot, so that the card won't be pulled out; for this reason, the card is pushed deeper passing the lock craw. This makes it difficult for a user to take the card out by holding the edge portion of the card with his fingers; for this reason, an auto eject mechanism is provided to eject the card automatically. The auto eject mechanism allows the holding body which is holding a card be energized toward the ejecting direction with a spring; when the lock by the latch mechanism is released, the card in the holding body is pushed toward the ejecting direction by the energizing force of the spring.

[Patent Reference 1] Japanese Patent Laid-Open No. 2004-341647

When a card reader for magnetic cards with a magnetic strip adopts a structure in which a card is inserted by hand and ejected by the auto eject operation as in Patent Reference 1, a magnetic strip of a card is made to contact a magnetic head arranged inside the card insertion slot and is moved along the magnetic head as the card is pushed in, to either read or write magnetic data.

However, when the auto eject mechanism disclosed in Patent Reference 1 is mounted in a card reader for magnetic cards, a card is pushed against a holding body during the insertion and pushed into the card reader together with the holding body. For this reason, the card hits the holding body during the reading or writing of magnetic data, and therefore, impact is applied to the card, possibly degrading the accuracy of the reading or writing of magnetic data.

Considering the above problem, the present disclosure is, in a card reader equipped with a magnetic head and an auto eject mechanism, to prevent impact on a card during the reading and/or writing of magnetic data.

### SUMMARY

To solve the above described problem, a magnetic card reader of the present disclosure includes a card insertion slot, a card pathway into which a card is inserted at the card insertion slot, a magnetic head arranged at a reading-writing position in the card pathway, a holder for holding the card, a body frame for movably holding the holder between an insertion complete position and an insertion-waiting position in the card pathway, and an energizing mechanism for energizing the holder from the insertion complete position toward the insertion-waiting position; the holder is provided with a card-receiving part on which the leading edge of the card in the card-inserting direction abuts, and the distance between the card-receiving part of the holder in the insertion-waiting position and the reading-writing position in the card pathway in the card insertion direction is longer than the length from the leading edge of the card in the card-inserting direction to the rear edge of the magnetic data recording range in the card-inserting direction.

In the present disclosure, the distance between the card-receiving part of the holder positioned in the insertion-waiting position and the reading/writing position in the card pathway in the card-inserting direction is longer than the length from the leading edge of the card in the card-inserting direction to the rear edge of the magnetic data recording range in the card-inserting direction. Therefore, the card won't reach the card-receiving part of the holder before the magnetic data recording range on the card passes the reading-writing position in the card pathway. For this reason, the card does not hit the card-receiving part while the magnetic data recording range is still passing the reading/writing position, and therefore, the card does not receive impact while magnetic data is being read and/or written.

In the present disclosure, it is preferred that the holder be provided with a holder position-regulating portion with which it is prevented from moving from the insertion-waiting position toward the card insertion slot. With this configuration, impact is prevented from being applied to the card while magnetic data is being read and/or written.

In the present disclosure, it is preferred that the holder be provided with a notch portion which is cut from the end portion thereof on the card insertion slot side in the card-inserting direction and a holding portion which holds the edge of the card at both sides of the notch portion in the direction which intersects with the card-inserting direction to be slidable in the card-inserting direction. With this configuration, the sliding load between the card and the holder can be reduced when the card is curved. Therefore, the card can be smoothly inserted or removed.

In the present disclosure, the card-receiving part is arranged at the edge of the notch portion on the front side in the card-inserting direction. Because of this, when a notch is formed in the holder, a card-receiving part can be created at the same time. Also, the receiving portion can be created to make contact with the center portion of the card in the width direction.

In the present disclosure, the card-receiving part is a receiving surface perpendicular to the card-inserting direction. With this, the card can be supported with stability. When the card and the holder are moved in the card-inserting direction or the opposite direction while in contact, the card and the holder don't move from their positions. Therefore, the card inserting operation and removing operation can be performed smoothly.

In the present disclosure, a card-locking mechanism is provided for moving a card latch lever between a protruding position which protrudes to the card insertion slot and a retracted position which is withdrawn from the card insertion slot; when the ejection of the card is prevented by the card latch lever which is positioned at the protruding position, the holder is held together with the card in the insertion complete position. Because of this, when the card latch lever is retracted, the holder is moved by the energizing mechanism to eject the card. Thus, the auto eject operation can be linked with the release of the card latch condition.

According to the present disclosure, the length of the magnetic data recording range on a card in the card-inserting direction is shorter than the distance from the reading-writing position in the card reader to the position of the card-receiving part of the holder in the insertion-waiting position; therefore, the card won't reach the card-receiving part before the magnetic data recording range on the card completely passes the reading-writing position in the card reader. Therefore, the card won't receive impact in the middle of the magnetic data reading and/or writing. Thus, magnetic data can be read and/or written accurately.

### BRIEF DESCRIPTION OF THE DRAWINGS

FIG. 1 is a perspective view of a magnetic card reader to which the present disclosure is applied, viewed from the magnetic head side.

FIG. 2 is a perspective view of the magnetic card reader of FIG. 1, viewed from the direction opposite the magnetic head side.

FIG. 3 is a plan view of a magnetic card.

FIG. 4A is a cross-sectional view of the magnetic card reader.

FIG. 4B is a plan view of the magnetic card reader.

FIG. 5 is a perspective view of the magnetic card reader having the front bezel removed, viewed from the direction opposite the magnetic head side.

FIGS. 6A and 6B are diagrams to explain the operation of the magnetic head (the state in which a magnetic card is inserted to a holder-contact position).

FIGS. 7A and 7B are diagrams to explain the operation of the magnetic head (the state in which a magnetic card is inserted to a card insertion complete position).

FIGS. 8A and 8B are diagrams to explain the operation of the magnetic head (the state of card latch).

### DESCRIPTION OF EMBODIMENTS

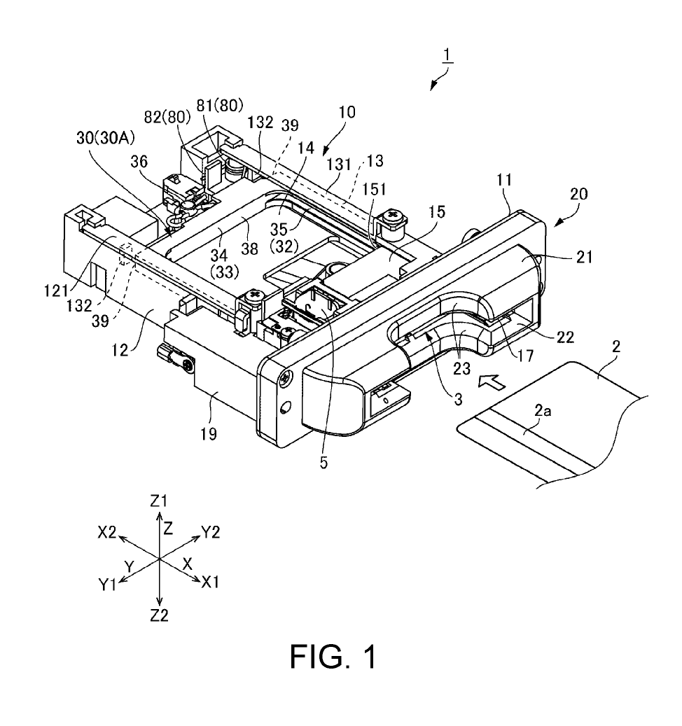

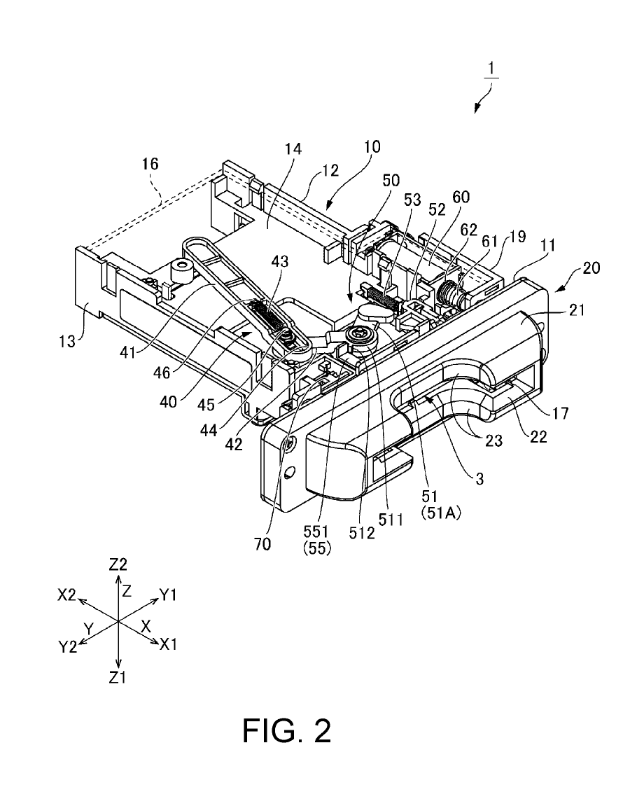

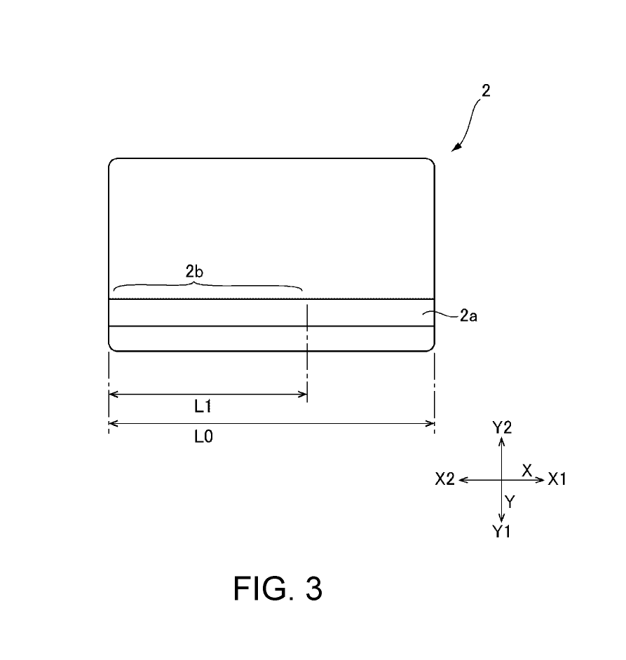

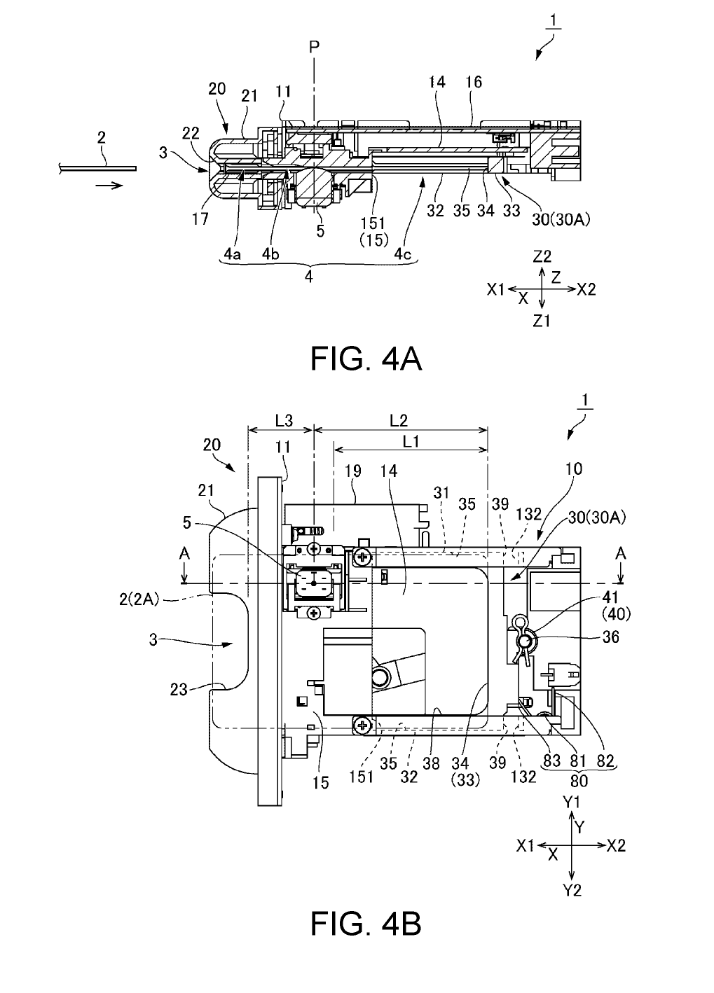

An embodiment of a magnetic card reader in which the present disclosure is applied is described hereinafter, referring to the drawings. FIG. 1 is a perspective view of a magnetic card reader 1 of the present disclosure, viewed from the side of the magnetic head 5. FIG. 2 is a perspective view of the magnetic card reader 1 of FIG. 1, viewed from the direction opposite the magnetic head 5 side. FIG. 1 and FIG. 2 show the state in which a magnetic card 2 is not inserted in the magnetic card reader 1. FIG. 3 is a plan view of the magnetic card 2. FIGS. 4A and 4B show a cross-sectional view and a plan view of the magnetic card reader 1. FIG. 4A is a cross-sectional view (the A-A cross section of FIG. 4B). FIG. 4B is a plan view, viewed from the magnetic head 5 side.

(Overall Configuration)

As shown in FIG. 1 and FIG. 4A, the magnetic card reader 1 is provided with a card insertion slot at which a magnetic card 2 is inserted. As shown in FIG. 4A, a card pathway 4, to which the magnetic card 2 is inserted from the card insertion slot 3, is created inside the magnetic card reader 1. The magnetic card reader 1 performs either reading or writing or both of magnetic data with respect to the magnetic card 2 having a magnetic strip 2a formed thereon (referring to FIG. 3). The magnetic card reader 1 is provided with a magnetic head 5 arranged at a reading-writing position P in the card pathway 4.

In this specification, the X, Y and Z directions are perpendicularly intersecting with each other. The X direction is a front-back direction of the magnetic card reader 1; the X1 direction is the front side and the X2 direction is the back side. The card pathway 4 extends in the X direction. The X2 direction is the inserting direction of the magnetic card 2 from the card insertion slot 3 (the card-inserting direction); the X1 direction is the card-ejecting direction. Also, the Y direction is the width direction of the magnetic card 2 in the card pathway 4 (the card-width direction); one side in the Y direction is Y1 and the other side is Y2. The magnetic head 5 is arranged closer to the Y1 side in the Y direction in the card pathway 4. The Z direction is the thickness direction of the magnetic card 2 in the card pathway 4 (the card thickness direction): one side in the Z direction is Z1 and the other side is Z2. As shown in FIG. 4A, the magnetic head 5 is arranged on the Z1 side in the Z direction in the card pathway 4.

As shown in FIG. 3, the magnetic card 2 is substantially rectangular. The magnetic strip 2a is located closer to the end portion on one side in the short direction of the magnetic card 2 and extends in the longitudinal direction of the magnetic card 2. The magnetic card 2 is inserted at the card insertion slot 3 while the longitudinal direction thereof coincides in the X direction. When the magnetic card 2 is inserted to the card pathway 4, the magnetic strip 2a contacts the magnetic head 5. The magnetic data recording range 2b, in which magnetic data is recorded, is in a specific length in the X direction on the magnetic strip 2a. The length L1 of the magnetic data recording range 2b in the X direction is shorter than the entire length of magnetic card 2 in the X direction. In this embodiment, the magnetic data recording range 2b starts from the leading edge (the front edge) of the magnetic card 2 in the card-inserting direction (in the X2 direction). Note that, although FIG. 3 shows “a plan view” of the magnetic card 2, in which the magnetic strip 2a is formed on the “front side” of the card, it is only so for convenience in description and the present disclosure is not limited to processing only cards with this configuration (in which the magnetic strip is formed on the front side of the card). In this embodiment, the magnetic strip 2a can be on the “front side” or “the back side” of the magnetic card 2. Also, although FIG. 1 shows the magnetic card reader 1 which reads from and/or writes on the magnetic card 2 having the magnetic strip 2a on “the front side” (the magnetic card of JIS II standard) in the direction opposite the normal reading-writing direction, the present disclosure is not limited to this case. In other words, the present disclosure includes a magnetic card reader 1 which reads from and/or writes on a magnetic card 2 of ISO standard.

The magnetic card reader 1 is provided with a main frame 10, a front bezel 20 attached to the end portion on the front side X1 of the main frame 10, a holder 30 which is supported by the main frame 10 to move in the X direction, an energizing mechanism 80 for energizing the holder 30 toward the front side X1, a card-locking mechanism 50 which prevents the magnetic card 2, which is held in the holder 30, from being taken out from the card insertion slot 3, a solenoid 60 which is a drive source for the card-locking mechanism 50, and a linking mechanism 40 to link the card-locking mechanism 50 with the holder 30.

As shown in FIG. 1, FIG. 2 and FIG. 4A, the main frame 10 includes: a front frame 11 which extends in the Y direction; side frames 12 and 13 which are positioned on the back side X2 behind the front frame 11, separated in the Y direction, and extended in parallel in the X direction; a center frame 14, both ends in the Y direction of which are connected to the side frames 12 and 13; a magnetic head-holding frame 15 which is opposed to the center frame 14 in the Z direction; and a control board 16 which is arranged on the opposite side (on the other side Z2 in the Z direction) from the magnetic head-holding frame 15 with respect to the center frame 14. As shown in FIG. 4A, the magnetic head 5 is held in the magnetic head-holding frame 15 and faces the card pathway 4.

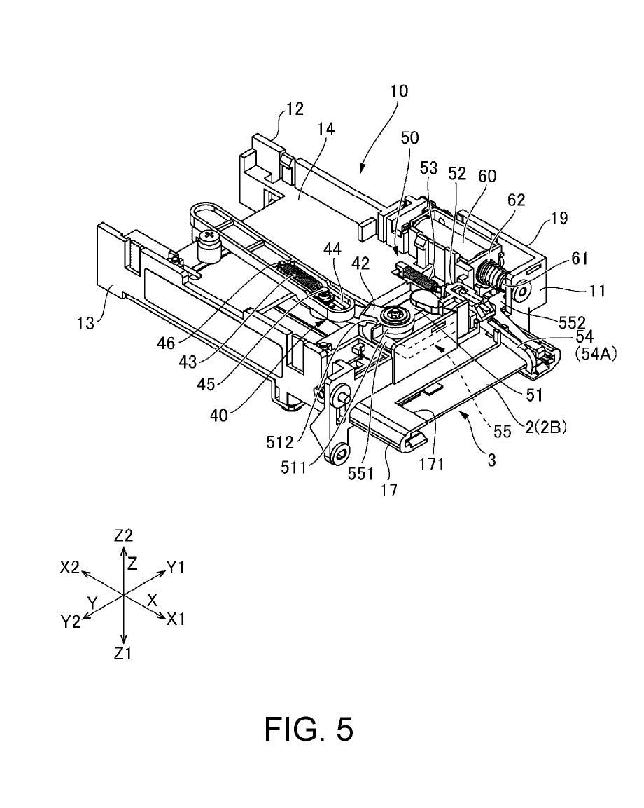

FIG. 5 is a perspective view of the magnetic card reader 1 with the front bezel 20 removed, viewed from the opposite side from the magnetic head 5. The main frame 10 has a card insertion slot-forming portion 17 which protrudes from the front frame 11 toward the front side X1. At the end portion on the front side X1 of the card insertion slot-forming portion 17, the card insertion slot 3 which spreads straight in the Y direction is formed. The card insertion slot-forming portion 17 has a notch portion 171 which is notched at the center portion thereof in the width direction (the Y direction) toward the back side X2.

The front bezel 20 is secured to the front frame 11, so as to configure the front portion of the magnetic card reader 1. As shown in FIG. 1, FIG. 2 and FIGS. 4A and 4B, a protruding portion 21 which protrudes to the front side X1 is formed in the approximate center of the front bezel 20 in the card width direction Y. The card insertion slot forming portion 17 is accommodated inside the protruding portion 21. The card insertion slot 3 opens up on the inner side of an opening portion 22 provided at the front end of the protruding portion 21. At the center of the protruding portion 21 in the width direction (the Y direction), a recess portion 23 which is recessed to the back side X2 is formed. With the auto eject operation which is described later, the magnetic card 2 comes to the state where the center portion thereof in the card width direction (the Y direction) is exposed in the recess portion 23 of the front bezel 20 (referring to FIG. 4B).

(Card Pathway)

As shown in FIG. 4A, the card pathway 4 has: a first passage portion 4a which is formed inside the protruding portion 21 of the front bezel 20 and the card insertion slot forming portion 17; a second passage portion 4b which is formed between the magnetic head-holding frame 15 and the center frame 14; and a third passage portion 4c which is arranged on the back side X2 of the magnetic holding frame 15 on one side Z1 in the Z direction of the center frame 14. The holder 30 is arranged in the third passage portion 4c. The magnetic card 2 is inserted at the card insertion slot 3 into the first passage portion 4a; when the magnetic card 2 passes in the second passage portion 4b, the magnetic strip 2a and the magnetic head 5 make contact with each other. The magnetic card reader 1 processes at least the magnetic data reading or writing while the magnetic card 2 moves with the magnetic data recoding range 2b in the magnetic strip 2a and the magnetic head 5 is in contact. As the magnetic card 2 proceeds from the second passage portion 4b to the third passage portion 4c, both ends of the magnetic card 2 in the card width direction (the Y direction) come into the holder 30 arranged in the third passage portion 4c, and thus the magnetic card 2 is held in the holder 30.

(Holding Structure of Holder by Main Frame)

As shown in FIG. 1, to the edges of the side frames 12 and 13 on one side Z1 in the Z direction, holding plates 121 and 131, which extend in the X direction, are attached. The end portion of the holding plate 121, 131 on the back side X2 is engaged with the side frame 12, 13, while the end portion of the holding plate 121, 131 on the front side X1 is screwed to the magnetic head-holding frame 15. The holding plates 121 and 131 create gaps with the center frame 14 in the same height on the back side X2 of the magnetic head-holding frame 15. Both end portions in the Y direction of the holder 30 are arranged in this gap. In other words, in the main frame 10, the holder holding portion is configured by the side frames 12 and 13, the center frame 14 and the holding plates 121 and 131 to hold both ends of the holder 30 in the Y direction to be movable in the X direction.

(Moving Range of Holder)

As shown in FIG. 1 and FIG. 4B, the main frame 10 has a frame side contact portion 132 positioned on the back side X2 of the holder 30. The frame side contact portion 132 is formed to each of the side frames 12 and 13. Also, a holder side contact portion 39 opposing the frame side contact portion 132 in the X direction is formed at both edges in the Y direction of the end surface of the holder 30 on the back side X2. The movement of the holder 30 to the back side X2 is restricted as the frame side contact portion 132 contacts the holder side contact portion 39. Also, a rear sensor (illustration omitted) is mounted on the control board 16 to detect that the holder 30 has moved to a predetermined position at the rear end of the main frame 10. The rear sensor is an optical sensor for detecting that a rib (no illustration) formed to the holder 30 has reached the position of the rear sensor.

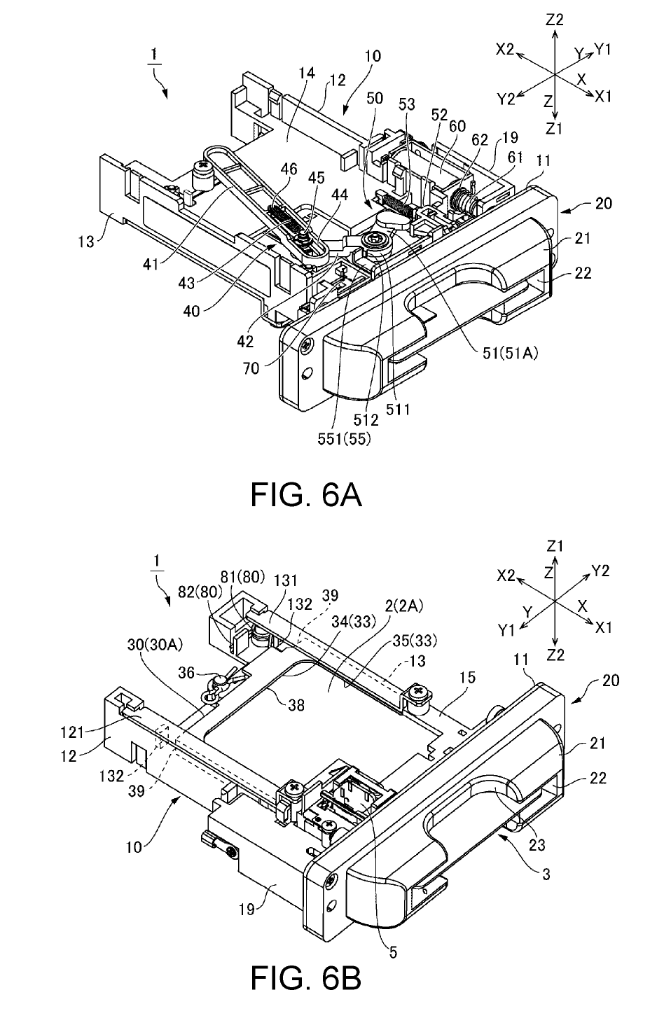

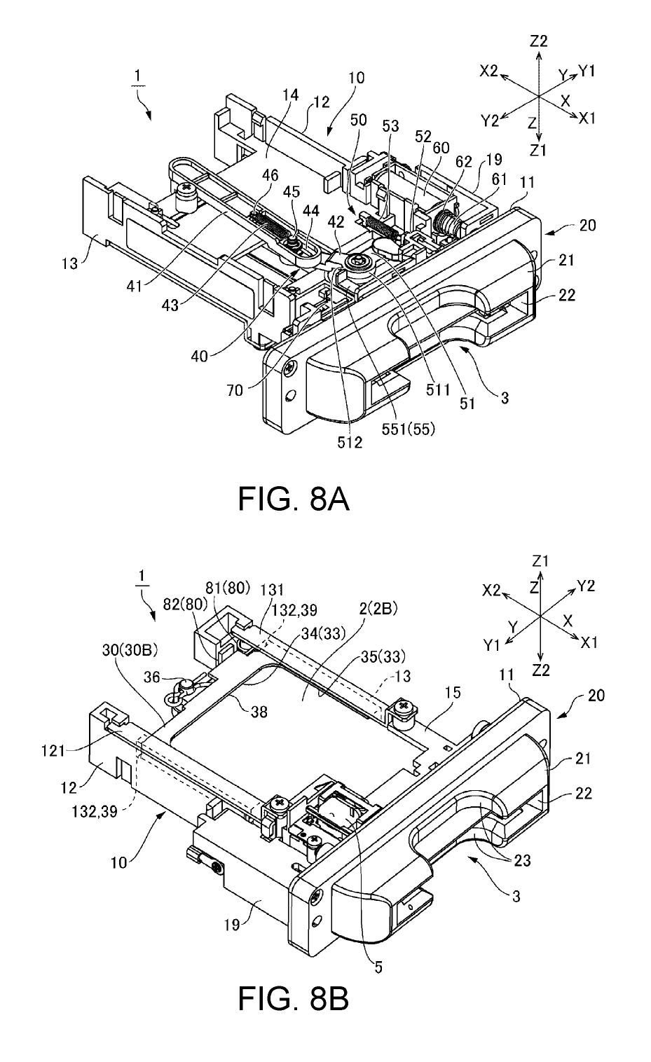

The main frame 10 also has a holder position-regulating portion 151 which is opposed in the X direction to the end surface on the front side X1 of the holder 30. As shown in FIG. 4A, the holder position-regulating portion 151 is configured on the end surface of the magnetic head-holding frame 15 on the back side X2. The holder 30 is held between an insertion-waiting position 30A (referring to FIG. 1, FIGS. 4A and 4B, and FIG. 6B), at which the end surface on the front side X1 thereof makes contact with the holder position-regulating portion 151, and an insertion complete position 30B (referring to FIG. 4B and FIG. 8B) on the back side X2 beyond the insertion-waiting position 30A, to be movable in the X direction.

(Magnetic Card Holding Structure by Holder)

In FIG. 4B, the shape of the magnetic card 2 inserted to the card pathway 4 is contoured by an alternate long- and short-dashed line. The holder 30 has a notch portion 38 which is notched in a rectangle shape at the center of the edge thereof on the front side X1 (i.e., on the card inserting-opening side) toward the back side X2 (i.e., in the card-inserting direction). The holder 30 also has a first holding portion 31 on one side Yl and a second holding portion 32 on the other side Y2 of the notch portion 38 in the Y direction, which extend parallel in the X direction, and a card-receiving part 33, which extends in the Y direction on the back side X2 of the notch portion 38. The card-receiving part 33 connects the end portions of the first holding portion 31 and the second holding portion 32 on the back side X2, and also has a card-receiving surface 34 which faces the front side X1. As shown in FIG. 1 and FIG. 4A, the card-receiving surface 34 is a flat surface perpendicular to the X direction.

As shown in FIG. 1 and FIG. 4B, a card holding groove 35 that faces the inside of the holder 30 in the width direction (the Y direction) is formed in the first holding portion 31 and the second holding portion 32. Into the card holding groove 35 in the first holding portion 31, the end portion of the magnetic card 2 on one side Yl in the Y direction (the card width direction) is to be inserted. Into the card holding groove 35 in the second holding portion 32, the end portion of the magnetic card 2 on the other side Y2 in the Y direction (the card width direction) is to be inserted. The magnetic card 2 is held with both end portions thereof in the card width direction (the Y direction) by the first holding portion 31 and the second holding portion 32 to be movable in the X direction.

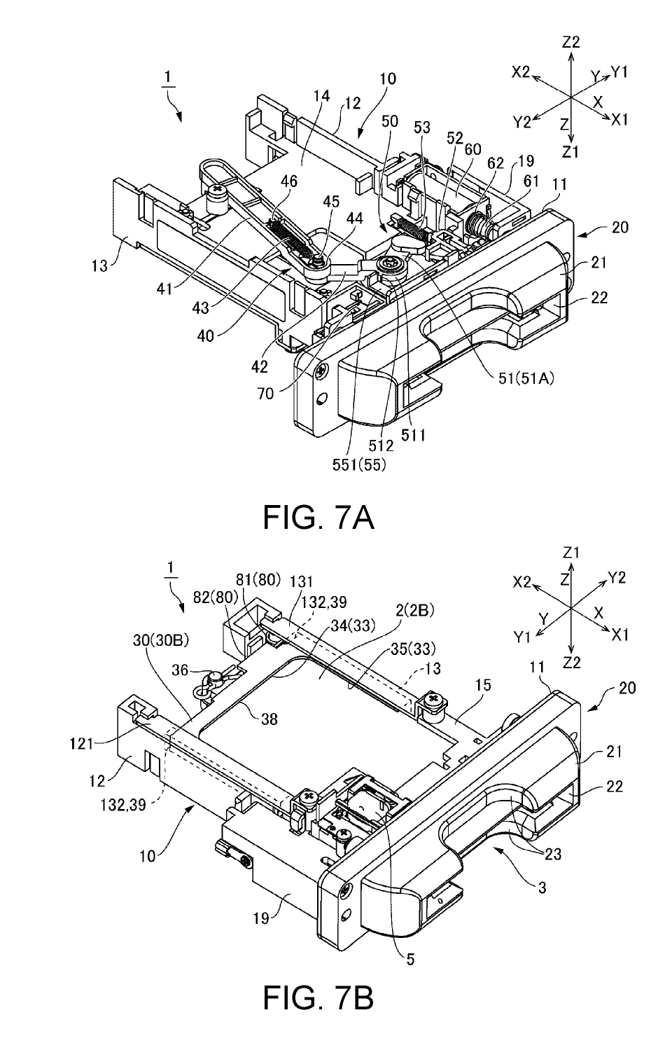

As the magnetic card 2 proceeds from the second passage portion 4b to the third passage portion 4c, both ends of the magnetic card 2 in the card width direction (the Y direction) come into the card holding groove 35 in the card holder 30 which is arranged in the third passage portion 4c. When the leading edge of the magnetic card 2 in the card-inserting direction (i.e., the edge on the back side X2 of the magnetic card reader 1) comes into contact with the card-receiving surface 34 of the holder 30, the holder 30 is pushed by the magnetic card 2 from that point and moves together with the magnetic card 2 further to the back side X2. FIG. 4B shows the state in which the magnetic card 2 is in contact with the card-receiving surface 34 while the holder 30 is in the insertion-waiting position 30A. The position of the magnetic card 32 shown in FIG. 4B is hereinafter defined as a holder contact position 2A. The magnetic card 2 is in a card insertion complete position 2B when the holder 30 is pushed all the way to the insertion complete position 30B (see FIG. 7B and FIG. 8B).

(Energizing Mechanism)

The holder 30 is being energized toward the front side X1 by the energizing mechanism 80. When the magnetic card 2 contacts the holder 30 and moves the holder 30 to the back side X2, the holder 30 is moved against the energizing force of the energizing mechanism 80. In this embodiment, the energizing mechanism 80 is equipped with a torsion coil spring 81 which is positioned between the rear end of the holder 30 and the main frame 10. One end portion of the torsion coil spring 81 is engaged with a frame side engaging portion 82 (see FIG. 4B) formed in the main frame 10. The other end portion of the torsion coil spring 81 is engaged with a holder side engaging portion 83 (see FIG. 4B) formed in the holder 30. Therefore, when the holder 30 moves to the back side X2, the torsion coil spring 81 is compressed to energize the holder 30 to the front side X1.

(Connection Mechanism)

As shown in FIG. 2, on the other side Z2 in the Z direction of the center frame 14, a linking mechanism 40 which links a card-locking mechanism 50, which is described later, with the holder 30 is arranged. The linking mechanism 40 is configured by a first lever 41, a first arm 42 and an energizing member 43 which connects the first lever 41 and the first arm 42. The first arm 42 is rotatably supported by the center frame 14.

The end portion on the back side X2 of the first lever 41 is rotatably linked with a fulcrum pin 36 arranged at the end portion on the back side X2 of the holder 30 (see FIG. 2 and FIG. 4B). In a long hole 44 formed in the end portion on the front side X1 of the first lever 41, a pin 45, which is formed in the tip end of the first arm 42 is engaged to be slidable as shown in FIG. 2 and FIG. 5. The energizing member 43 is a coil spring; one end thereof is linked with the pin 45 provided to the first arm 42 and the other end thereof is fixed to a fixing pin 46 provided to the first lever 41. The fixing pin 46 is positioned on the back side X2 beyond the long hole 44. Therefore, when the holder 30 is pushed by the magnetic card 2 and moved to the back side X2, the first lever 41 moves to the back side X2 to stretch the energizing member 43. While the energizing member 43 is stretched, the holder 30 is energized to the front side X1 via the first lever 41.

(Card Locking Mechanism)

The first arm 42 arranged in the linking mechanism 40 is formed integrally with a second arm 51 arranged in a card-locking mechanism 50. As shown in FIG. 2, the second arm 51 protrudes to one side Y1 in the Y direction from the shaft portion 511 which is rotatably supported by the main frame 10. On the other hand, the first arm 42 protrudes to the other side Y2 in the Y direction from the shaft portion 511. Because the first arm 42 is energized by the energizing member 43 to rotate to the back side X2, the second arm 51 is energized to rotate to the front side X1. On the outside circumferential surface of the shaft portion 511 is formed an engagement portion 512. As shown in FIG. 2, when a stopper member 55 engages with the engagement portion 512 from the back side X2, the first arm 42 and the second arm 51 are respectively restricted from rotating in the directions in which they are respectively energized by the energizing member 43. By this operation, the second arm 51 is held in a card latch release position 51A which is withdrawn from the latch lever driving member 52 to the back side X2.

As shown in FIG. 5, the card-locking mechanism 50 is configured by the second arm 51, the latch lever driving member 52 arranged opposing the tip end of the second arm 51, a return spring 53 which energizes the latch lever driving member 52 to the back side X2, a card latch lever 54 engaged with the latch lever driving member 52, and a stopper member 55 which engages with the engagement portion 512 provided on the shaft portion 511 of the second arm 51 to restrict the rotations of the second arm 51 and the first arm 42. The stopper member 55 is bent over and rotatably supported to the center frame 14 by a fulcrum pin which is not illustrated. The stopper member 55 has a first arm piece 551 extending from the fulcrum pin (no illustration) to the back side X2 and a second arm piece 552 extending between the latch lever driving member 52 and the center frame 14 to the solenoid 60 side.

The solenoid 60 is the drive source of the card-locking mechanism 50. The solenoid 60 is held in a solenoid storing portion 19 which sticks out in a rectangular shape from the side surface of the main frame 10 to one side Y1 in the Y direction. A plunger 61 of the solenoid 60 is energized to the front side X1 by a plunger return spring 62. The second arm piece 552 of the stopper member 55 is engaged with the plunger 61. Therefore, the stopper member 55 rotates when the solenoid 60 is driven.

(Operations of Magnetic Card Insertion and Auto Eject)

FIG. 6A through FIG. 8B are diagrams to explain the operations of the magnetic card reader 1. FIGS. 6A and 6B show the state of the magnetic card reader 1 in which the magnetic card 2 is inserted until the holder contact position 2A. FIGS. 7A and 7B show the state in which the magnetic card 2 is inserted until the card insertion complete position 2B. FIGS. 8A and 8B show the state of card latch. FIG. 6A, FIG. 7A and FIG. 8A are respectively perspective views of the magnetic card reader 1, viewed from the opposite side from the magnetic head 5 side. FIG. 6B, FIG. 7B and FIG. 8B are respectively perspective views of the magnetic card reader 1, viewed from the magnetic head 5 side.

In the card insertion-waiting state as shown in FIG. 1, the holder 30 has proceeded to the insertion-waiting position 30A and been in contact with the holder position-regulating portion 151 of the magnetic head holding frame 15. Also, as shown in FIG. 2, in the card insertion-waiting state, the stopper 55 is engaged from the back side X2 with engagement portion 512 formed in the shaft portion 511 of the first arm 42 and the second arm 51, and the second arm 51 is held in the card latch-releasing position 51A. Therefore, the latch lever driving member 52 is pulled back to the back side X2 by the return spring 53, and the card latch lever 54 is retracted from the card inserting-opening 3. Thus, the insertion of the magnetic card 2 at the card insertion slot 3 is made possible.

Once inserted at the card insertion slot 3, the magnetic card 2 proceeds to the holder contact position 2A at which it contacts the card-receiving surface 34 of the holder 30. In this embodiment, the magnetic data reading and writing with respect to the magnetic card 2 is completed, before the magnetic card 2 reaches the holder contact position 2A. In other words, in the magnetic card reader 1, the distance L2 between the card-receiving surface 34 of the holder 30 positioned in the insertion-waiting position 30A and the reading-writing position P in the X direction of the magnetic head 5 (see FIG. 4B) is longer than the length L1 from the edge on the back side X2 of the magnetic card 2 (the front edge in the card-inserting direction) to the end portion of the magnetic data recording range 2b on the front side X1 of the magnetic card 2 (the rear edge in the card-inserting direction) (see FIG. 3 and FIG. 4B). Configured in this manner, the rear edge of the magnetic data recording range 2b in the card-inserting direction completes passing the reading-writing position P of the magnetic head 5, before the front edge of the magnetic card 2 in the card-inserting direction comes into contact with the card-receiving surface 34 of the holder 30. Therefore, the magnetic card 2 is prevented from contacting the card-receiving surface 34 of the holder 30, while the magnetic data is being read/written; thus, no impact is applied on the magnetic card 2.

When proceeding to the holder contact position 2A, the magnetic card 2 makes contact with the card-receiving surface 34 on the holder 30 as shown in FIG. 6B. As the magnetic card 2 is pushed further to the back side X2 from this state, the holder 30 is pushed into the insertion complete position 30B as shown in FIG. 7B. When the holder 30 further proceeds from the insertion-waiting position 30A to the insertion complete position 30B, the linking mechanism 40 operates, as shown in FIG. 7A, such that the first lever 41 moves to the back side X2 together with the holder 30 and the energizing member 43 is pulled and stretched to the back side X2. On the other hand, the card-locking mechanism 50 restricts the rotations of the second arm 51 and the first arm 42 with the stopper member 55. At this time, the torsion coil spring 81 of the energizing mechanism 80 is compressed; therefore, the holder 30 is energized to the front side X1.

The magnetic card reader 1 is also equipped with a front sensor 70 which detects that the magnetic card 2 is inserted at the card insertion slot 3 and a rear sensor (no illustration) which detects that the holder 30 has reached the insertion complete position 30B. When the holder 30 reaches to the insertion complete position 30B, the outputs from the front sensor 70 and the rear sensor (no illustration) become detectable. Triggered by the detectable outputs from the front sensor 70 and the rear sensor (no illustration), the control unit of the magnetic card reader 1 drives the solenoid for a short time (about several ten milli seconds).

When the solenoid 60 is electrified, the card-locking mechanism 50 pulls the plunger 61 to the back side X2, and then the stopper member 55 rotates, and the first arm piece 551 of the stopper member 55 leaves the shaft portion 511. Through this operation, the engagement portion 512 and the first arm piece 551 are disengaged from each other. At that time, the energizing member 43 is in stretch, energizing the first arm 42; as soon as the engagement portion 512 and the first aim piece 551 are disengaged from each other, the first arm 42 rotates to the back side X2. As a result, the second arm 51 rotates to the front side X1. The latch lever driving member 52 is pushed by the second arm 51, which has moved to the front side X1, and moved to the front side X1 to move the card latch lever 54 to the protruding position 54A (see FIG. 5) which protrudes to the card insertion slot 3.

When the electrification of the solenoid 60 is stopped, the plunger 61 is returned to the home position by the plunger return spring 62; therefore, the stopper member 55 rotates in the reverse direction of the direction it rotated during the electrification of the solenoid, and the first arm piece 551 of the stopper member 55 returns to the shaft portion 511 side. Although the engagement portion 512 and the first arm piece 551 are disengaged from each other only for a short time (about several ten milli seconds), the first arm 42 rotates to the back side X2 as soon as the engagement portion 512 and the first arm piece 551 are disengaged from each other. Therefore, as shown in FIG. 8A, when the first arm piece 551 of the stopper member 55 returns to the shaft portion 511, the engagement portion 512 is positioned on the back side X2 of the first arm piece 551. Thus, the second arm 51 is restricted from rotating to the back side X2 by the stopper member 55, and the card latch lever 54 is held in the protruding portion 54A. This is the state of card latch.

To eject the magnetic card 2, the magnetic card reader 1 drives the solenoid 60 again for a short time (about several ten milli seconds) in the card latch state shown in FIGS. 8A and 8B, so as to perform the auto eject operation by which the magnetic card 2 is ejected via the holder 30. When the solenoid 60 is electrified in the card latch state, the stopper member 55 rotates to cancel the engagement between the engagement portion 512 and the first arm piece 551. Consequently, the first arm 42 and the second arm 51 become rotatable; at the moment the solenoid 60 is driven, the latch lever driving member 52 and the second arm 51 are returned to the back side X2 by the energizing force of the return spring 53. Accordingly, the card latch lever 54 returns to the retracted position (no illustration) at which it withdraws from the card insertion slot 3. With this, the card latch lever 54 which has been engaged with the front edge of the magnetic card 2 comes off the magnetic card 2, and therefore, the magnetic card 2 is now movable to the front side X1. Then, the magnetic card 2 is moved together with the holder 30 to the front side X1 by the energizing force of the energizing mechanism 80. The holder 30 makes contact with the holder position-regulating portion 151 and stops at the insertion-waiting position 30A. Then, the magnetic card 2 is ejected to the holder contact position 2A (see FIGS. 6A and 6B).

(Major Effects of This Embodiment)

As described above, the magnetic card reader 1 of this embodiment is configured such that the distance L2 between the card-receiving surface 34 on the holder 30, which is positioned in the insertion-waiting position 30A, and the reading-writing position P of the magnetic head 5 is longer than the length L1 from the edge of the magnetic card 2 on the back side X2 (the leading edge in the card-inserting direction) to the end portion on the front side X1 of the magnetic data recording range 2b (the rear end in the card-inserting direction). Because of this, the magnetic card 2 will not hit the card-receiving surface 34 of the holder 30, while the magnetic data recording range 2b on the magnetic card 2 is passing the reading-writing position P; therefore, no impact is applied on the magnetic card 2 while magnetic data is being read or written. Thus, the magnetic data reading and writing can be performed precisely.

Note that, in this embodiment, the insertion-waiting position 30A of the holder 30 is the position at which the leading edge of the magnetic card 2, which is inserted at the card insertion slot 3 by hand, can make contact with the card-receiving surface 34 of the holder 30. Therefore, in this embodiment, as shown in FIG. 4B, the end portion on the front side X1 of magnetic card 2 (the rear end in the insertion direction), which is in contact with the card-receiving surface 34 of the holder 30 positioned in the insertion-waiting position 30A is protruding from the card insertion slot 3 to the outside by a predetermined length. More specifically described, the end portion on the front side X1 of the magnetic card 2 sits more on the front side X1 than the recessed surface of the recess portion 23 within the recess portion 23 of the front bezel 20. Then, to push the holder 30 in from this position via the magnetic card 2 which is pushed by hand, the above-described distance L2 needs to be set at least shorter than the length (L0 minus L3), where L0 is the length of the magnetic card 2 in the X direction (the entire length in the card inserting-direction) (see FIGS. 3), and L3 is the distance from the reading-writing position P to the card insertion slot 3 (see FIG. 4B). In other words, if the total length of the distance L3 from the reading-writing position P to the card insertion slot 3 and the above-described distance L2 is shorter than the entire length L0 of the magnetic card 2, the energizing mechanism 80 will not energize even when the magnetic card 2 is pushed in. Note that, in this embodiment, the distance L3 from the reading-writing position P to the card insertion slot 3 means the distance from the reading-writing position P to the inside surface of the most-deeply recessed portion to the back side X2 in the recess portion 23 of the front bezel 20.

In this embodiment, the holder position-regulating portion 151 is formed to the main frame 10 of the magnetic card 1, so as to restrict the holder 30 from moving toward the card insertion slot 3 past the insertion-waiting position 30A. Therefore, the holder 30 will not move toward the card insertion slot 3 past the inserting-waiting position 30A; thus, impact is prevented on the magnetic card 2 while magnetic data is being read and/or written.

The holder 30 of this embodiment has the notch portion 38 which is notched at the end portion thereof on the card insertion slot 3 side in the card-inserting direction (to the back side X2), and the first holding portion 31 and the second holding portion 32 provided at both sides of the notch portion 38 in the card-width direction (in the Y direction). The first holding portion 31 and the second holding portion 32 hold the end portion of the magnetic card 2 to be slidable in the card-inserting-direction (to the X1 side) and the card-ejecting direction (to the X2 side). As described, the holder 30 is notched except the portion overlapping the edge of the magnetic card 2 when viewed from the card thickness direction (the Z direction); therefore, when the magnetic card 2 happens to be curved, the sliding load between the magnetic card 2 and the holder 30 can be reduced. Therefore, the magnetic card 2 can be inserted and removed smoothly, and thus, the magnetic data reading and writing can be performed precisely. Also, when the notch portion 38 is provided, the inside surface of the notch portion 38 can be used as the card-receiving surface 34 to make contact with the center portion of the magnetic card 2 in the width direction. Therefore, the magnetic card 2 can be held in a simply shaped surface but in a stable manner.

In this embodiment, the card-receiving surface 34 of the holder 30 is a flat surface perpendicular to the card-inserting direction (X2 direction). Therefore, the magnetic card 2 can be supported in the stable manner, and there is little possibility that the contact position between the magnetic card 2 and the card-receiving surface 34 shifts. Therefore, the insertion operation and removal operation of the magnetic card 2 can be smoothly performed, facilitating the precise magnetic data reading and writing.

The magnetic card reader 1 of this embodiment is equipped with the card-locking mechanism 50 which moves the card latch lever 54 between the protruding position 54A, which protrudes to the card insertion slot 3, and the retracted position which is withdrawn from the card insertion slot 3; when the card latch lever 54 positioned in the protruding position 54A prevents the magnetic card 2 from being ejected, the holder 30 is held in the insertion complete position 30B with the magnetic card 2. In this way, the auto-ejecting operation on the magnetic card 2 can be performed following the releases of the card latch condition; therefore, the magnetic card 2 can be ejected with certainty and the control over the ejection is simple.

What is claimed is,:

1. A magnetic card reader, comprising:
a card insertion slot;
a card pathway into which a card is inserted from the card insertion slot;
a magnetic head arranged at a reading-writing position in the card pathway;
a holder to hold the card;
a main frame which holds the holder movable between an insertion complete position and an insertion-waiting position in the card pathway; and
an energizing mechanism which energizes the holder from the insertion complete position toward the insertion-waiting position;
wherein the holder has a card-receiving part on which a leading edge of the card in a card-inserting direction makes contact, and
a distance between the card-receiving part in the insertion-waiting position and the reading-writing position in the card-inserting direction is longer than a length from the leading edge of the card in the card-inserting direction to a rear edge of a magnetic data recording range in the card-inserting direction.

2. The magnetic card reader as set forth in claim 1, further comprising:
a holder position-regulating portion, being provided to restrict the holder from moving from the insertion-waiting position toward the card insertion slot.

3. The magnetic card reader as set forth in claim 2, wherein the holder comprises:
a notch portion, which is cut from an end portion on a side of the card insertion slot in the card-inserting direction; and
a holding portion, which hold an end portion of the card from both sides of the notch portion in a direction perpendicular to the card-inserting direction to be slidable in the card-inserting direction.

4. The magnetic card reader as set forth in claim 3, wherein
the card-receiving part is provided to a front edge of the notch portion in the card-inserting direction.

5. The magnetic card reader as set forth in claim 4, wherein
the card-receiving part is a receiving surface perpendicular to the card-inserting direction.

6. The magnetic card reader as set forth in claim 4, further comprising:
a card-locking mechanism, being provided for moving a card latch lever between a protruding position, which protrudes to the card insertion slot, and a retracted position, which is withdrawn from the card insertion slot, and
the holder is held together with the card in the insertion complete position when an ejection of the card is prevented by the card latch lever positioned in the protruding position.

7. The magnetic card reader as set forth in claim 3, wherein
the card-receiving part is a receiving surface perpendicular to the card-inserting direction.

8. The magnetic card reader as set forth in claim 3, further comprising:
a card-locking mechanism, being provided for moving a card latch lever between a protruding position, which protrudes to the card insertion slot, and a retracted position, which is withdrawn from the card insertion slot, and
the holder is held together with the card in the insertion complete position when an ejection of the card is prevented by the card latch lever positioned in the protruding position.

9. The magnetic card reader as set forth in claim 2, wherein
the card-receiving part is a receiving surface perpendicular to the card-inserting direction.

10. The magnetic card reader as set forth in claim 2, further comprising:
a card-locking mechanism, being provided for moving a card latch lever between a protruding position, which protrudes to the card insertion slot, and a retracted position, which is withdrawn from the card insertion slot, and
the holder is held together with the card in the insertion complete position when an ejection of the card is prevented by the card latch lever positioned in the protruding position.

11. The magnetic card reader as set forth in claim 1, wherein the holder comprises:
a notch portion, which is cut from an end portion on a side of the card insertion slot in the card-inserting direction; and
a holding portion, which hold an end portion of the card from both sides of the notch portion in a direction perpendicular to the card-inserting direction to be slidable in the card-inserting direction.

12. The magnetic card reader as set forth in claim 11, wherein
the card-receiving part is provided to a front edge of the notch portion in the card-inserting direction.

13. The magnetic card reader as set forth in claim 12, wherein
the card-receiving part is a receiving surface perpendicular to the card-inserting direction.

14. The magnetic card reader as set forth in claim 12, further comprising:
a card-locking mechanism, being provided for moving a card latch lever between a protruding position, which protrudes to the card insertion slot, and a retracted position, which is withdrawn from the card insertion slot, and
the holder is held together with the card in the insertion complete position when an ejection of the card is prevented by the card latch lever positioned in the protruding position.

15. The magnetic card reader as set forth in claim 11, wherein
the card-receiving part is a receiving surface perpendicular to the card-inserting direction.

16. The magnetic card reader as set forth in claim 11, further comprising:
a card-locking mechanism, being provided for moving a card latch lever between a protruding position, which protrudes to the card insertion slot, and a retracted position, which is withdrawn from the card insertion slot, and
the holder is held together with the card in the insertion complete position when an ejection of the card is prevented by the card latch lever positioned in the protruding position.

17. The magnetic card reader as set forth in claim 1, wherein
the card-receiving part is a receiving surface perpendicular to the card-inserting direction.

18. The magnetic card reader as set forth in claim 17, further comprising:
a card-locking mechanism, being provided for moving a card latch lever between a protruding position, which protrudes to the card insertion slot, and a retracted position, which is withdrawn from the card insertion slot, and
the holder is held together with the card in the insertion complete position when an ejection of the card is prevented by the card latch lever positioned in the protruding position.

19. The magnetic card reader as set forth in claim 1, further comprising:
a card-locking mechanism, being provided for moving a card latch lever between a protruding position, which protrudes to the card insertion slot, and a retracted position, which is withdrawn from the card insertion slot, and
the holder is held together with the card in the insertion complete position when an ejection of the card is prevented by the card latch lever positioned in the protruding position.
